(19) United States
(12) Patent Application Publication
(10) Pub. No.: US 2017/0371761 A1
(43) Pub. Date: Dec. 28, 2017

(54) REAL-TIME PERFORMANCE TRACKING USING DYNAMIC COMPILATION

(71) Applicant: Advanced Micro Devices, Inc., Sunnyvale, CA (US)

(72) Inventors: Leonardo Piga, Austin, TX (US); Brian J. Kocoloski, Pittsburgh, PA (US); Wei Huang, Frisco, TX (US); Abhinandan Majumdar, Ithaca, NY (US); Indrani Paul, Round Rock, TX (US)

(21) Appl. No.: 15/192,748

(22) Filed: Jun. 24, 2016

(51) Int. Cl. G06F 11/36; G06F 9/45

(52) U.S. Cl. CPC G06F 11/3604; G06F 8/443

(57) ABSTRACT

Systems, apparatuses, and methods for performing real-time tracking of performance targets using dynamic compilation. A performance target is specified in a service level agreement. A dynamic compiler analyzes a software application executing in real-time and determine which high-level application metrics to track. The dynamic compiler then inserts instructions into the code to increment counters associated with the metrics. A power optimization unit then utilizes the counters to determine if the system is currently meeting the performance target. If the system is exceeding the performance target, then the power optimization unit reduces the power consumption of the system while still meeting the performance target.

### BACKGROUND

### Technical Field

Embodiments described herein relate to computing systems and more particularly, to performing real-time performance tracking utilizing dynamic compilers.

### Description of the Related Art

Managing power consumption in computing systems, integrated circuits (ICs), processors, and system-on-chips (SoCs) is increasingly important. In addition to power consumption, performance is another factor to be considered when utilizing computers and other types of processor-based electronic systems. Generally speaking, higher performance results in a higher amount of power consumed. Conversely, limiting the amount of power consumed limits the potential performance of a computer or other type of processor-based electronic system.

Programs and applications that execute on computing systems are typically generated from source code files written by a programmer. In some environments, source code is compiled into an intermediate type of code. One example of an intermediate type of code is “bytecode.” In some cases, the intermediate code is interpreted at runtime. In other cases, an additional compilation step is performed on the intermediate code. For example, dynamic compilers may perform just-in-time compilation to compile bytecode into native code during execution of the software application.

When a software application is being executed, a computing system may monitor the performance of the system hardware. Some computing systems include performance counters in the system hardware to track low level events such as instructions executed per second. While tracking such events is useful in some cases, in other cases it would be desirable to be able to monitor and responds to higher level events such as higher level transactions.

### SUMMARY

Systems, apparatuses, and methods for performing real-time performance tracking utilizing dynamic compilation are contemplated.

In various embodiments, a performance target for a computing system is determined. In one embodiment, the performance target is specified in a service level agreement (SLA). In other embodiments, the performance target is specified by a user or otherwise. In one embodiment, the performance target specifies a percentage of the maximum performance for a given computing system. In another embodiment, the performance target is specified as a performance level, such as high, medium, low. In a further embodiment, the performance target is specified according to various metrics such as transactions per second, round-trip latency, frames per second, request-response time, etc.

In one embodiment, a dynamic compiler is configured to analyze code of a software application and identify sequences of instructions deemed to corresponds to higher level transactions. In various embodiments, the dynamic compiler is a runtime compiler configured to receive and compile an intermediate type code such as bytecode. The dynamic compiler inserts additional instructions in the code to track the high-level transactions. In one embodiment, the additional instructions conveys an indication corresponding to the occurrence of the transaction (or “event”). For example, values indicative of the high-level application events are written to registers of the processor(s) of the computing system. A power optimization unit in the computing system utilizes the indication of events to determine if the computing system is meeting a specified performance target. If the computing system is exceeding the specified performance target, then the power optimization unit reduces the operating parameters (e.g., power performance state (P-state)) of one or more components of the computing system in order to reduce power consumption. If the computing system is not meeting the specified performance target, then the power optimization unit increases operating parameters of one or more components of the computing system in order to increase performance so that the specified performance target is met.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram of one embodiment of a computing system.

FIG. 2 is a block diagram of one embodiment of a software development cycle.

FIG. 3 is a block diagram of one embodiment of host hardware.

FIG. 4 illustrates one embodiment of a control flow graph.

FIG. 5 is a generalized flow diagram illustrating one embodiment of a method for tracking performance targets in real-time using dynamic compilation.

FIG. 6 is a generalized flow diagram illustrating another embodiment of a method for tracking performance targets in real-time.

FIG. 7 is a generalized flow diagram illustrating one embodiment of a method for calibrating a computing system.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

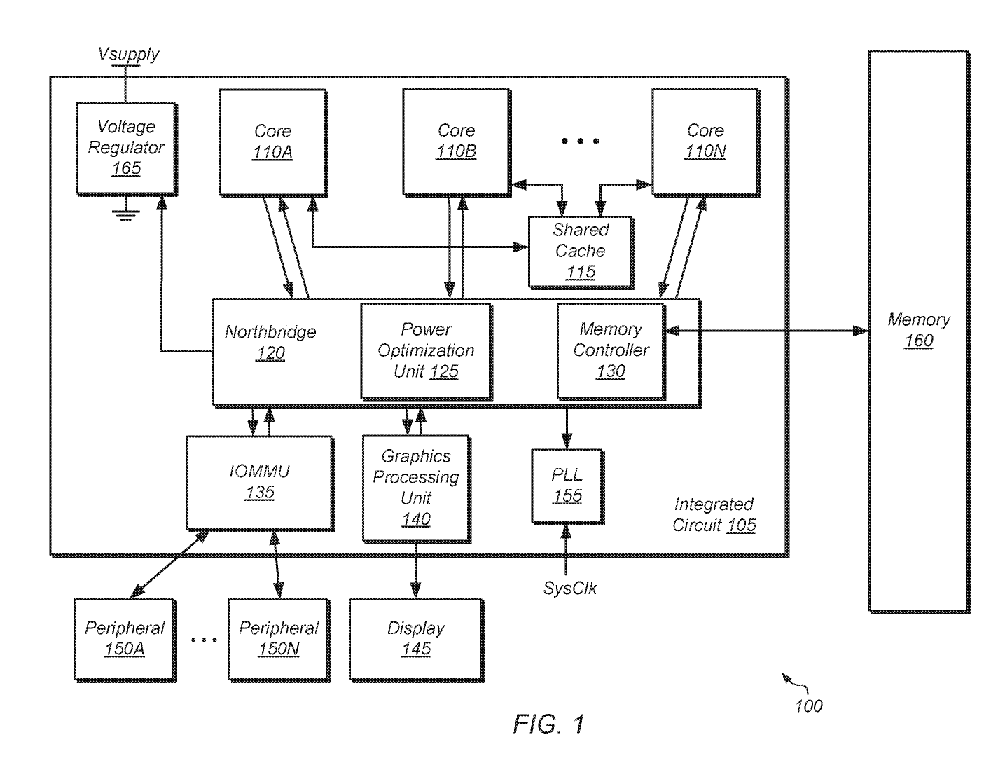

FIG. 1 is a block diagram of a computing system 100, in accordance with some embodiments. In these embodiments, computing system 100 includes integrated circuit (IC) 105 coupled to memory 160. In one embodiment, IC 105 is a system on a chip (SoC). In some embodiments, IC 105 includes a plurality of processor cores 110A-N. In other embodiments, IC 105 includes a single processor core 110. In multi-core embodiments, processor cores 110 are identical to each other (i.e., symmetrical multi-core), or one or more cores are different from others (i.e., asymmetric multi-core). Each processor core 110 includes one or more execution units, cache memories, schedulers, branch prediction circuits, and so forth. Furthermore, each of processor cores 110 is configured to assert requests for access to memory 160, which functions as main memory for computing system 100. Such requests include read requests and/or write requests, and are initially received from a respective processor core 110 by northbridge 120.

Input/output memory management unit (IOMMU) 135 is also coupled to northbridge 120 in the embodiment shown. IOMMU 135 functions as a south bridge device in computing system 100. A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) is coupled to IOMMU 135. Various types of peripheral devices 150A-N are coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices 150A-N that are coupled to IOMMU 135 via a corresponding peripheral bus may assert memory access requests using direct memory access (DMA). These requests (which include read and write requests) are conveyed to northbridge 120 via IOMMU 135.

In some embodiments, IC 105 includes a graphics processing unit (GPU) 140 that is coupled to display 145 of computing system 100. In some embodiments, GPU 140 is an integrated circuit that is separate and distinct from IC 105. Display 145 is a flat-panel LCD (liquid crystal display), plasma display, a light-emitting diode (LED) display, or any other suitable display type. GPU 140 performs various video processing functions and provide the processed information to display 145 for output as visual information.

In some embodiments, memory controller 130 is integrated into northbridge 120. In some embodiments, memory controller 130 is separate from northbridge 120. Memory controller 130 receives memory requests conveyed from northbridge 120. Data accessed from memory 160 responsive to a read request is conveyed by memory controller 130 to the requesting agent via northbridge 120. Responsive to a write request, memory controller 130 receives both the request and the data to be written from the requesting agent via northbridge 120. If multiple memory access requests are pending at a given time, memory controller 130 arbitrates between these requests.

In one embodiment, power optimization unit 125 is integrated into northbridge 120. In other embodiments, power optimization unit 125 is separate from northbridge 120 and/or power optimization unit 125 is implemented as multiple, separate components in multiple locations of IC 105. Power optimization unit 125 includes one or more counters for tracking one or more high-level application metrics for software applications executing on IC 105.

In some embodiments, memory 160 includes a plurality of memory modules. Each of the memory modules includes one or more memory devices (e.g., memory chips) mounted thereon. In some embodiments, memory 160 includes one or more memory devices mounted on a motherboard or other carrier upon which IC 105 is also mounted. In some embodiments, at least a portion of memory 160 is implemented on the die of IC 105 itself. Embodiments having a combination of the aforementioned embodiments are also possible and contemplated. Memory 160 is used to implement a random access memory (RAM) for use with IC 105 during operation. The RAM implemented is static RAM (SRAM) or dynamic RAM (DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, IC 105 also includes one or more cache memories that are internal to the processor cores 110. For example, each of the processor cores 110 includes an L1 data cache and an L1 instruction cache. In some embodiments, IC 105 includes a shared cache 115 that is shared by the processor cores 110. In some embodiments, shared cache 115 is an L2 cache. In some embodiments, each of processor cores 110 has an L2 cache implemented therein, and thus shared cache 115 is an L3 cache. Cache 115 is part of a cache subsystem including a cache controller.

In the embodiment shown, IC 105 includes a phase-locked loop (PLL) unit 155 coupled to receive a system clock signal. PLL unit 155 includes a number of PLLs configured to generate and distribute corresponding clock signals to each of processor cores 110 and to other components of IC 105. In this embodiment, the clock signals received by each of processor cores 110 are independent of one another. Furthermore, PLL unit 155 in this embodiment is configured to individually control and alter the frequency of each of the clock signals provided to respective ones of processor cores 110 independently of one another. The frequency of the clock signal received by any given one of processor cores 110 is increased or decreased in accordance with performance demands imposed thereupon. The various frequencies at which clock signals are output from PLL unit 155 may correspond to different operating points for each of processor cores 110. Accordingly, a change of operating point for a particular one of processor cores 110 is put into effect by changing the frequency of its respectively received clock signal.

In the case where changing the respective operating points of one or more processor cores 110 includes the changing of one or more respective clock frequencies, power optimization unit 125 changes the state of digital signals provided to PLL unit 155. Responsive to the change in these signals, PLL unit 155 changes the clock frequency of the affected processing node(s). Additionally, power optimization unit 125 also causes PLL unit 155 to inhibit a respective clock signal from being provided to a corresponding one of processor cores 110.

In the embodiment shown, IC 105 also includes voltage regulator 165. In other embodiments, voltage regulator 165 is implemented separately from IC 105. Voltage regulator 165 provides a supply voltage to each of processor cores 110 and to other components of IC 105. In some embodiments, voltage regulator 165 provides a supply voltage that is variable according to a particular operating point (e.g., increased for greater performance, decreased for greater power savings). In some embodiments, each of processor cores 110 shares a voltage plane. Thus, each processing core 110 in such an embodiment operates at the same voltage as the other ones of processor cores 110. In another embodiment, voltage planes are not shared, and thus the supply voltage received by each processing core 110 is set and adjusted independently of the respective supply voltages received by other ones of processor cores 110. Thus, operating point adjustments that include adjustments of a supply voltage are selectively applied to each processing core 110 independently of the others in embodiments having non-shared voltage planes. In the case where changing the operating point includes changing an operating voltage for one or more processor cores 110, power optimization unit 125 changes the state of digital signals provided to voltage regulator 165. Responsive to the change in the signals, voltage regulator 165 adjusts the supply voltage provided to the affected ones of processor cores 110. In instances in power is to be removed from (i.e., gated) one of processor cores 110, power optimization unit 125 sets the state of corresponding ones of the signals to cause voltage regulator 165 to provide no power to the affected processing core 110.

In one embodiment, a dynamic compiler (not shown) is configured to analyze the instructions of a software application executing on computing system 100. The dynamic compiler detects instructions which are indicative of a high-level application metric during execution of the software application. The dynamic compiler then modifies the user software application by adding one or more additional instructions to track the high-level application metric. In one embodiment, the additional instruction(s) are used to increment a counter. In another embodiment, the additional instruction(s) are used to generate timing information associated with one or more events. The additional instruction(s) are then executed to track the high-level application metric. Power optimization unit 125 then determines if the software application is meeting a performance target based on a value of the high-level application metric. In some cases, power optimization unit 125 is configured to simultaneously monitor a plurality of high-level application metrics to determine if the software application is meeting a performance target.

In various embodiments, computing system 100 is a computer, laptop, mobile device, server, web server, cloud computing server, storage system, or other types of computing systems or devices. It is noted that the number of components of computing system 100 varies from embodiment to embodiment. There can be more or fewer of each component/subcomponent than the number shown in FIG. 1. It is also noted that computing system 100 includes many other components not shown in FIG. 1.

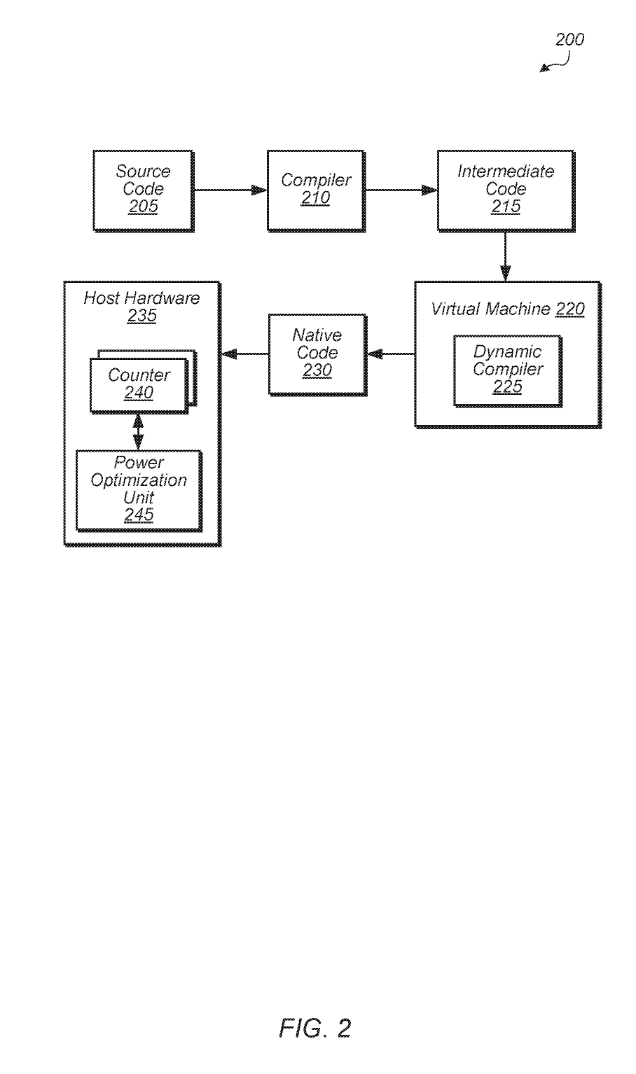

Turning now to FIG. 2, a block diagram of one embodiment of a software development cycle 200 is shown. In one embodiment, source code 205 is compiled by compiler 210 into intermediate code 215. Then, intermediate code 215 is executed using virtual machine 220 which includes dynamic compiler 225. Dynamic compiler 225 performs dynamic (or just-in-time) compilation of intermediate code 215 to generate native code 230. Dynamic compiler 225 is also configured to identify high-level application events in intermediate code 215. Dynamic compiler inserts one or more instructions into native code 230 to track the occurrence of the high-level application events. Native code 230 executes on host hardware 235, which includes one or more of the components of computing system 100.

When native code 230 executes, the instruction inserted by dynamic compiler 225 is used to increment one or more counters 240 of host hardware 235. Power optimization unit 245 of host hardware 235 is configured to monitor counters 240 and determine if the execution of a software application is meeting a specified performance target based on the value of counters 240. Power optimization unit 245 is configured to adjust the parameters of host hardware 235 to increase or decrease performance based on a comparison between the values of counters 240 and the performance target. The one or more parameters include a number of active processor cores, processor voltage, processor frequency, northbridge power state, memory frequency, and/or other parameters.

Increasing the performance of the system hardware includes one or more of increasing the number of active processor cores, increasing the voltage and/or frequency supplied to the processor core(s), increasing the memory frequency, increasing the northbridge power state, and/or one or more other actions.

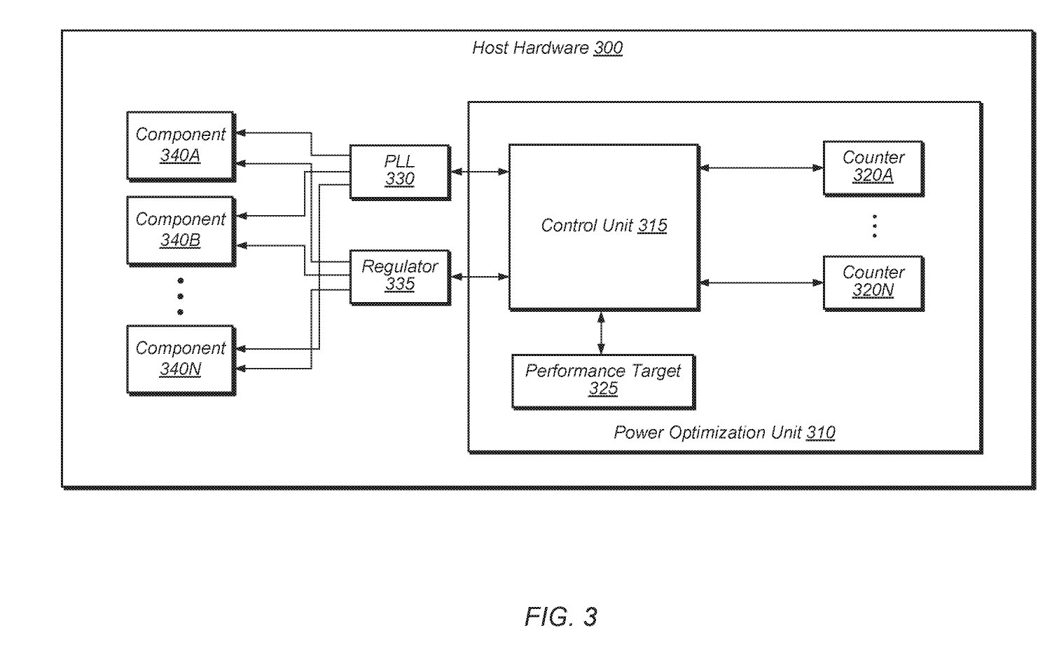

Referring now to FIG. 3, a block diagram of one embodiment of host hardware 300 is shown. In one embodiment, host hardware 300 corresponds to integrated circuit 105 of computing system 100 (of FIG. 1). Host hardware 300 includes power optimization unit 310, phase-locked loop (PLL) unit 330, regulator 335, and components 340A-N. Host hardware 300 also includes one or more other components not shown in FIG. 3 to avoid obscuring the figure. In one embodiment, power optimization unit 310 corresponds to power optimization unit 125 of FIG. 1. Components 340A-N are representative of any number and type of components (e.g., processor cores, IOMMU, northbridge, cache, GPU, memory devices, peripheral devices, display). PLL unit 330 includes a number of PLLs configured to generate and distribute corresponding clock signals to each of components 340A-N. Regulator 335 provides a supply voltage to each of components 340A-N. In one embodiment, host hardware 300 is part of a cloud computing environment.

Power optimization unit 310 is configured to program PLL unit 330 and regulator 335 to generate clock signals and supply voltages for components 340A-N which will enable software executing on components 340A-N to meet performance target 325. In one embodiment, performance target 325 is specified by a user. For example, performance target 325 is extracted from a service level agreement (SLA). Alternatively, a user selects performance target 325 from a plurality of possible performance targets generated and presented to the user in a graphical user interface by a host system or apparatus.

Power optimization unit 310 includes control unit 315 and counters 320A-N for determining how to program PLL unit 330 and regulator 335. In one embodiment, a software application executing on components 340A-N of host hardware 300 is configured to write to or increment counters 320A-N as various high-level application events occur. In some embodiments, a dynamic compiler (e.g., dynamic compiler 225 of FIG. 2) is configured to analyze the software application and insert instructions to increment one or more of counters 320A-N when any of various events occur. For example, each time a transaction is performed in the software application, a corresponding counter 320 is incremented to track a number of transactions performed. Other counters 320A-N are configured to simultaneously track other metrics (e.g., round-trip latency, request-response time, frames per second, total amount of work performed).

Control unit 315 is configured to monitor counters 320A-N and determine if performance target 325 is being met. In one embodiment, control unit 315 attempts to reach performance target 325 while minimizing power consumption of components 340A-N. Control unit 315 monitors as many of counters 320A-N which are active for a given embodiment. In some embodiments, only a single one of counters 320A-N is utilized. For example, in one embodiment, only transactions per second is tracked using a single counter 320 for a given software application. In other embodiments, control unit 315 simultaneously monitors multiple counters 320A-N to determine if performance target 325 is being met. It is noted that depending on the embodiment, counters 320A-N are implemented using registers, counters, or any other suitable storage elements.

In one embodiment, control unit 315 performs a direct comparison of one or more counters 320A-N to the performance target 325. For example, performance target 325 specifies a given number of transactions per second and a given counter 320 tracks the number of transactions per second being performed on host hardware 300 for a given software application. In another embodiment, control unit 315 performs a translation or conversion of the values of one or more of counters 320A-N to determine if performance target 325 is being met. For example, performance target 325 specifies a level (e.g., high, medium, low) or a percentage (e.g., 50%, 70%) of maximum performance, and control unit 315 converts one or more of counters 320A-N to a value which can be compared to performance target 325. In some embodiments, control unit 315 combines multiple values from counters 320A-N utilizing different weighting factors to create a single value which can be compared to performance target 325. In some embodiments, a calibration procedure is performed on host hardware 300 with power optimization unit 310 tracking various metrics during different periods of time when host hardware 300 is operated at a highest operating point and a lowest operating point. Power optimization unit 310 and control unit 315 then utilizes interpolation to determine values and metrics associated with other operating points in between the highest and lowest operating points. In some cases, the calibration procedure is performed at intermediate operating points rather than just the highest and lowest operating points.

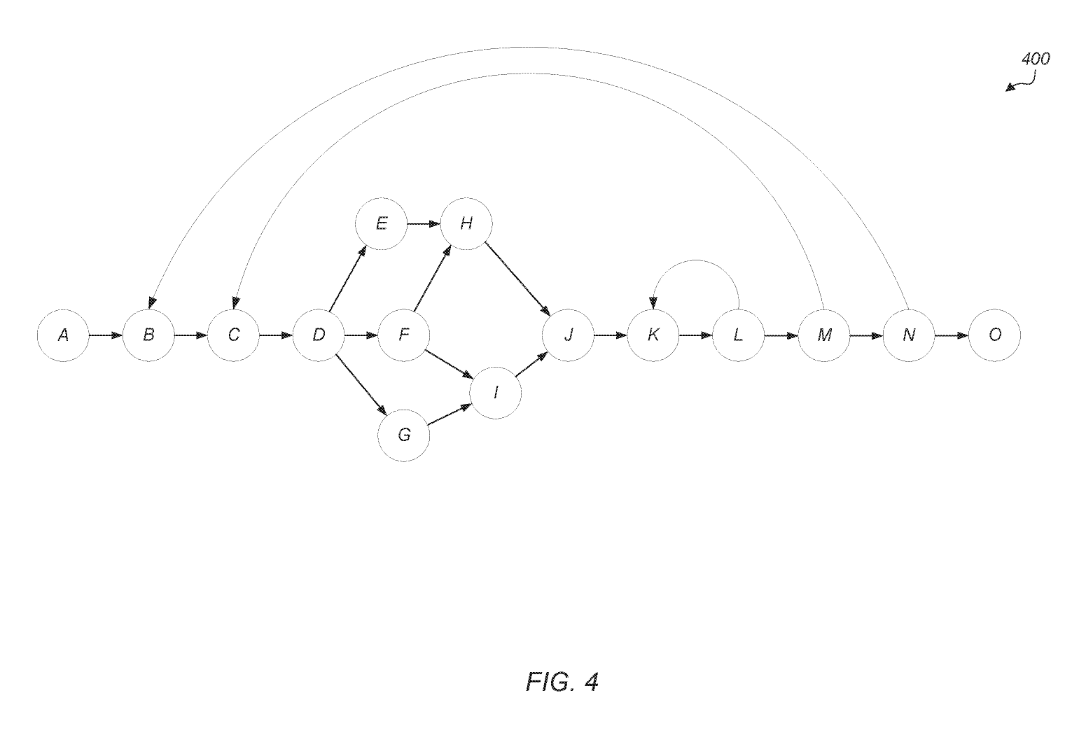

Turning now to FIG. 4, one embodiment of a control flow graph 400 for an application is shown. In one embodiment, a transaction is defined as a series of steps that work to accomplish a particular task. For example, a transaction can be an iteration of a simulation, servicing of a web server request, a database operation, or some other type of operations. In the example control flow graph 400 of FIG. 4, each vertex (A, B, C, . . . O) represents a “basic block” and each edge (depicted as an arrow from one vertex to another) represents a possible transition in the program flow from one basic block to another. A basic block is a series of sequential instructions in the program code where the only entry to the sequence of instructions is through the first instruction of the sequence and the only exit from the sequence of instructions if through the last instruction in the sequence.

In one embodiment, a dynamic compiler is configured to identify an outermost loop (e.g, the sequence B→ . . . →N→B) in program code (e.g., intermediate code) during run-time compilation. In some embodiments, the compiler is configured to generate a control flow graph(s) based on analysis of the program code and identify loops based on the control flow graph. In various embodiments, such an outermost loop is deemed to correspond to a high level transaction. In various embodiments, loops other than the outermost loop are also identified and deemed to correspond transactions. As one example, the dynamic compiler is configured to identify a particular portion of program code as corresponding to a particular type of database transaction. In various embodiments, such a portion is identified based on indications within the code itself (e.g., instructions that identify a particular module, function, procedure, library, method, etc.). By identifying an outermost loop within the portion, the compiler designates that loop as representing the database transaction. As may be appreciated, the actual number of low level operations or instructions that make up such a transaction can vary significantly and can be relatively large.

One metric that is used to capture performance of a software application is transaction throughput. Given a selected performance target, a control unit (e.g., power optimization unit 310 of FIG. 3) is used to select a hardware configuration that seeks to maximize, or otherwise improve, power efficiency while maintaining the target. In some cases, hardware events such as instructions per second are sometimes monitored and are used as proxies for transactions. However, such events often do not correlate well to software transactions, especially if a single transaction involves multiple phases (e.g., memory intensive, CPU intensive) and many instructions. To address such shortcomings, a dynamic compiler is used to provide real-time application level performance feedback to the processor on higher level transactions of interest. Such an approach can provide more accurate metrics without requiring modification of the source code. For example, in some embodiments, virtual machines are used to detect software transactions and dynamic compilers in virtual machines generate the program control flow in real time to do the optimizations. In one embodiment, the inputs to the virtual machine include a user specified high level performance target (e.g., a desired number of high level transactions per second, or otherwise) and the maximum performance level that can be achieved by the system.

As noted above, a dynamic compiler (e.g., dynamic compiler 225 of FIG. 2) is configured to identify the outer most loop B→ . . . →N→B of control flow graph 400. Responsive to identifying the loop, the dynamic compiler inserts an instruction(s) into the compiled code that is configured to keep a count of the number of iterations of the loop executed. In one embodiment, a transaction counter is located in a power optimization unit (e.g., power optimization 310 of FIG. 3). The transaction counter then tracks the number of such transactions. For example, in one embodiment, the count is reset on a periodic basis. In such a manner, the number of transactions per a given period of time (e.g., per second or otherwise) could be tracked. The transaction counter is then used to determine if a performance target is being met.

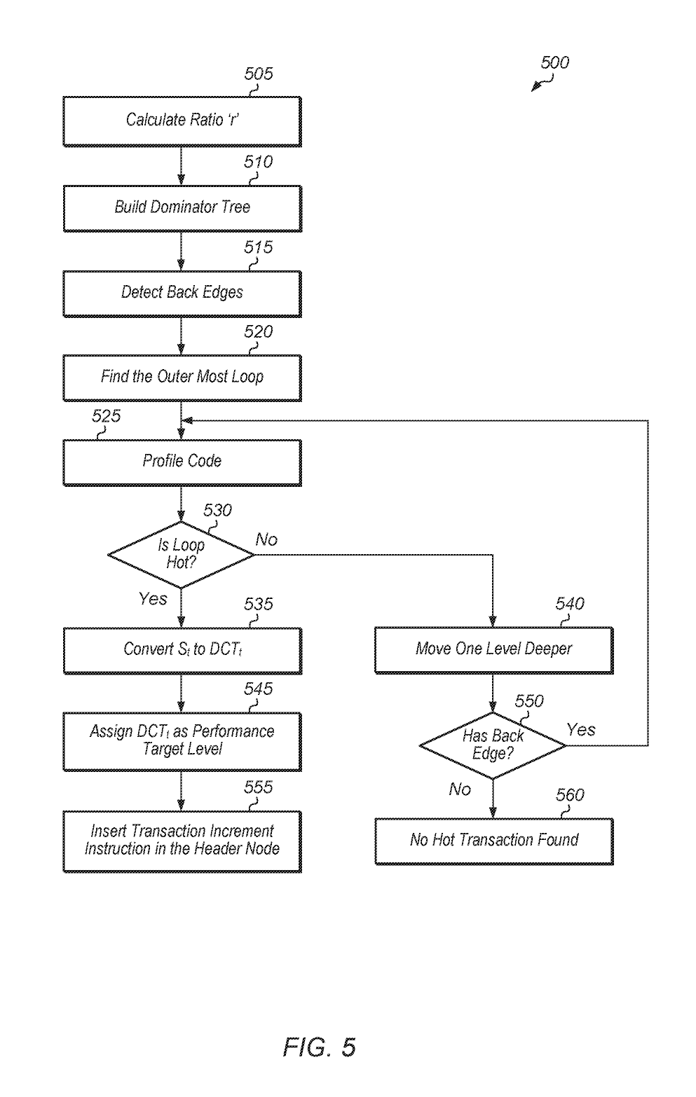

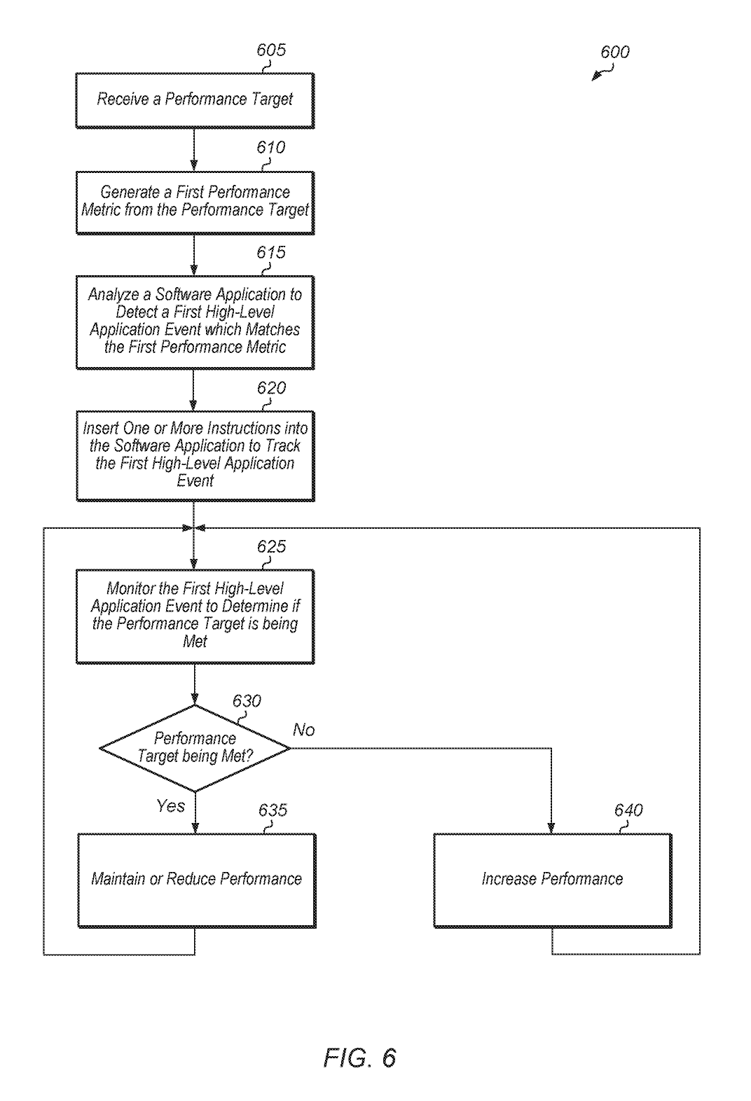

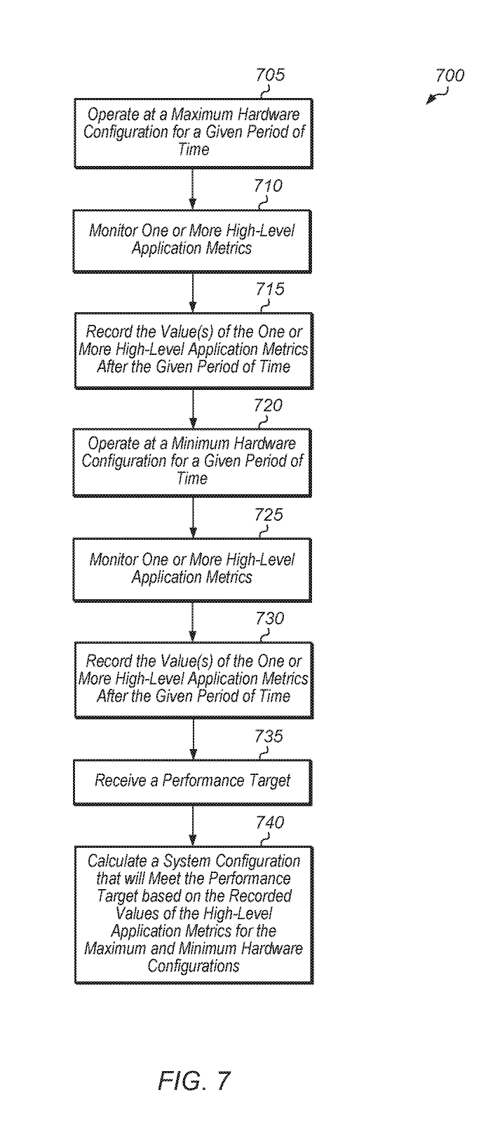

Referring now to FIG. 5, one embodiment of a method 500 for tracking performance targets in real-time using dynamic compilation is shown. For purposes of discussion, the steps in this embodiment and those of FIGS. 6 and 7 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

In various embodiments, a dynamic compiler (e.g., dynamic compiler 225 of FIG. 2) is configured to calculate a ratio ‘r’ between a software performance target ‘Sₜ’ and a maximum software performance level ‘Sₘₐₓ’ (block 505). Accordingly, the ratio ‘r’ is calculated by dividing the value of ‘Sₜ’ by ‘Sₘₐₓ’ (i.e., r=Sₜ/Sₘₐₓ). In one embodiment, the software performance target ‘Sₜ’ is specified in a service level agreement (SLA). For example, in one scenario, the software performance target ‘Sₜ’ is specified as a number of transactions per second. In other scenarios, the software performance target ‘Sₜ’ is specified as other high-level application metrics such as round-trip latency, request-response times, frames per second, performance dependency, total amount of work, or other metrics. In a further embodiment, the SLA specifies a performance target in terms of a performance level (e.g., high performance, medium performance, low performance), as a percentage of the maximum system performance, or otherwise. In various embodiments, the various performance levels offered by a service provider are translated (or mapped) to transactions of interest of a customer. For example, if a given customer is interested in achieving or maintaining a particular type of high level transaction per second (e.g., a particular type of database operation), then the SLA identifies various performance levels in terms of the indicated type of high level transaction per second. By utilizing the methods and mechanisms described herein, the SLA identifies and monitors these high level transactions and adjust system performance as needed to meet the terms of the SLA.

Having determined a transaction of interest, the dynamic compiler analyzes the software application (program code) to identify and/or build a dominator tree of the software application being executed (block 510). Generally speaking, when building and analyzing control flow graphs, a dominator tree is a tree in the control flow graph where each node of the tree dominates its children's nodes. A first node is said to dominate a second node if every path from an entry node to the second node must pass through the first node. Having built a control flow graph for the program code, the dynamic compiler detects back edges (i.e., branches within the code that branch back to an earlier point in the program code) of the software application (block 515). Such back edges are indicative of loops in the software application that represent a repeated operation or transaction. Next, the dynamic compiler finds the outer most loop of the software application (block 520). These outermost loops represent higher level transactions within the program code. In some embodiments, each iteration of this loop is designated a dynamic compiler transaction (DCT), or “transaction”. Having identified such a transaction, the dynamic compiler modifies the program code (block 525) by inserting instructions in the code that are configured to monitor the identified transaction(s).

When determining which loops/transactions to monitor, the dynamic compiler is configured to consider additional factors. For example, in some embodiments the compiler is configured to identify loops or transactions that are “hotter” than others. Generally speaking, a loop or transaction is considered hotter than another if it is repeated more often. If a loop is determined to be relatively hot (conditional block 530, “yes” leg), then the dynamic compiler modifies the program code to track that loop during execution. In some embodiments, a loop is deemed hot if the number of iterations exceeds a threshold number of iterations. As described above, such tracking involves conveying an indication that the loop or transaction has occurred, or has occurred a given number of times. In response, the system alters performance parameters depending on whether a performance target is being met. For example, a performance target is N transactions per a given interval. The received indication indicates the monitored transaction has occurred (N−M) times during the given interval. As such, the performance target is not being met and the system alters performance parameters to increase performance. Altering performance parameters to increase performance includes one or more of increasing an operating frequency, increasing allocation of various resources, or otherwise.

In various embodiments, the “count” of transactions that is indicated is modified when determining whether a performance target is being met. In some embodiments, the system is configured to convert the software performance target ‘Sₜ’ to a dynamic compiler transaction target (DCTₜ) (block 535). Such a conversion is performed by the compiler or by another entity in the system. In some embodiments, this DCTₜ is assigned as the performance target level (block 545). For example, it is determined that the maximum performance level of the system for a given transaction type is DCTₘₐₓ and it is determined that the performance target represents a given percent, r, of this maximum performance level. Therefore, DCTₜ=r×DCTₘₐₓ. Additionally, the dynamic compiler inserts a transaction increment instruction(s) in the program code (e.g., the first node of the loop) (block 555).

On the other hand, if an identified loop is not deemed hot (conditional block 530, “no” leg), then the dynamic compiler moves one level deeper (block 540) to a next inner level loop to examine a different loop. If the newly identified loop has a back edge (conditional block 550, “yes” leg), then method returns to block 525 to profile the code. If the loop does not have a back edge (conditional block 550, “no” leg), then the dynamic compiler concludes that no hot transaction has been found (block 560). After block 560, method 500 ends.

Turning now to FIG. 6, another embodiment of a method 600 for tracking performance targets in real-time is shown. In the example shown, a computing system receives a performance target (block 605). Such a performance target is identified in program code, read from a file, manually indicated, or otherwise. In one embodiment, the computing system extracts the performance target from a service level agreement (SLA). Next, the computing system generates a first performance metric from the performance target (block 610). In one embodiment, the performance target specifies a performance level (e.g., medium, high) or setting, and the computing system generates the first performance metric based on the performance level. For example, if the performance level is medium, then the computing system translates the medium performance level into a value of 100 transactions per second. In other scenarios, a medium performance level is translated into other metrics (e.g., round-trip latency, frames per second). In another embodiment, the first performance metric is specified in the SLA, and block 610 is skipped in this embodiment. In a further embodiment, the computing system generates multiple performance metrics (e.g., second performance metric, third performance metric) from the performance target.

Next, the computing system analyzes a software application to identify a first high-level application event which matches the first performance metric (block 615). For example, if the first performance metric is a specified number of transactions per second, then the computing system analyzes the software application to detect a corresponding transaction. In one embodiment, the computing system utilizes a dynamic compiler to analyze intermediate program code of the software application in order to identify the first high-level application event/transaction which matches or otherwise corresponds to the first performance metric.

Subsequent to identifying the transaction, the computing system inserts one or more instructions into the software application to track the first high-level application event (block 620). In one embodiment, the computing system inserts an instruction(s) to increment a count responsive to detecting an occurrence of first high-level application event. Next, the computing system monitors the first high-level application event to determine if the performance target is being met (block 625). In some embodiments, the computing system converts a count of the first high-level application event and counts of any number of other high-level application events into a value that corresponds to a performance target. For example, the performance target is specified as a percentage of the maximum software performance of the system. In this example, the count of the first high-level application event is converted into a percentage by dividing the count by the maximum attainable event frequency when the system is operating at peak performance. In other embodiments, other techniques for translating the count of the first high-level application event into a value that corresponds to a performance target are possible and are contemplated. Alternatively, in another embodiment, the performance target is converted into a value that corresponds to the count of the first high-level application event.

If the performance target is being met (conditional block 630, “yes” leg), then the computing system reduces one or more parameters of the computing system to reduce performance and to reduce power consumption (block 635). Otherwise, if the performance target is not being met (conditional block 630, “no” leg), then the computing system increases one or more parameters of the computing system to increase performance and to increase power consumption (block 640). It is noted that if a frequency (or other value) of the first high-level application event is within a given range of the performance target in conditional block 630, then the computing system maintains the current state of the system hardware, rather than increasing or reducing the one or more parameters. After blocks 635 and 640, method 600 returns to block 625 with the computing system continuing to monitor the first high-level application event to determine if the performance target is being met. It is noted that the computing system tracks and monitors multiple high-level application events in other embodiments to determine if the performance target is being met.

Referring now to FIG. 7, one embodiment of a method 700 for calibrating a computing system is shown. In the example shown, a computing system is operated at a maximum hardware configuration for a given period of time (block 705). In one embodiment, the maximum hardware configuration includes all processor cores active and operating at a highest possible power state (e.g., maximum voltage and frequency) and with other components (e.g., northbridge, memory) operating at their highest performance states. In other embodiments, operating at a maximum hardware configuration is with respect to a subset of resources of a computing system. As such, the maximum configuration does not include all hardware resources within the system. While the computing system is being operated at its maximum configuration, the computing system monitors one or more high-level application metrics (block 710). For example, in one embodiment, the computing system monitors a number of transactions of a software application that are executed per second. In other embodiments, the computing system monitors other high-level application metrics. Then, the computing system records the value(s) of the one or more high-level application metrics after the given period of time (block 715).

Next, the computing system is operated at a minimum hardware configuration for a given period of time (block 720). The minimum configuration corresponds to a lowest power state of the computing system where the computing system is still operable to execute applications. Similar to the above, the minimum configuration is with respect to a given set of resources of the system. While the computing system is being operated at its minimum configuration, the computing system monitors one or more high-level application metrics (block 725). Then, the computing system records the value(s) of the one or more high-level application metrics after the given period of time (block 730).

Next, the computing system receives a performance target (block 735). In one embodiment, the performance target is specified using one or more high-level application metrics. In one embodiment, the performance target is specified in a license agreement or service level agreement. Then, the computing system calculates a system configuration that will meet the performance target based on the recorded values of the high-level application metrics for the maximum and minimum hardware configurations (block 740). For example, in one embodiment, the computing system utilizes linear interpolation to calculate which system configuration will meet the performance target. For example, if 100 transactions were executed per second at the maximum configuration, if 40 transactions were executed per second at the minimum configuration, and the performance target specified 70 transactions per second, then the system configuration is set to a midpoint configuration to meet the performance target of 70 transactions per second. It is noted that in other embodiments, method 700 operates the computing system at multiple different configurations rather than just the maximum and minimum configuration. After block 740, method 700 ends.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
one or more memory devices; and
one or more processors;
wherein the system is configured to:
receive a performance target;
generate a first performance metric based on the performance target;
analyze a software application to detect a first high-level application event which corresponds to the first performance metric;
insert one or more instructions into the software application to track the first high-level application event; and
monitor the first high-level application event to determine if the performance target is being met.

2. The system as recited in claim 1, wherein the system is configured to:
insert one or more instructions into the software application to increment a count responsive to detecting each occurrence of the first high-level application event; and
monitor the count to determine if the performance target is being met.

3. The system as recited in claim 1, wherein the system is configured to extract the performance target from a service level agreement.

4. The system as recited in claim 1, wherein the first high-level application event is a transaction that includes a series of steps in an execution path of the software application with a common starting point that repeats during execution of the software application.

5. The system as recited in claim 1, wherein the system is further configured to:
generate a second performance metric based on the performance target;
analyze the software application to detect a second high-level application event which corresponds to the second performance metric;
insert one or more instructions into the software application to track the second high-level application event; and
monitor the first high-level application event and the second high-level application event to determine if the performance target is being met.

6. The system as recited in claim 1, wherein the system is configured to reduce a power state of the one or more processors responsive to determining the performance target is being met.

7. The system as recited in claim 1, wherein the system is configured to increase a power state of the one or more processors responsive to determining the performance target is not being met.

8. A method comprising:
receiving a performance target in a computing system;
generating a first performance metric based on the performance target;
analyzing a software application to detect a first high-level application event which corresponds to the first performance metric;
inserting one or more instructions into the software application to track the first high-level application event; and
monitoring the first high-level application event to determine if the performance target is being met.

9. The method as recited in claim 8, further comprising:
inserting one or more instructions into the software application to increment a count responsive to detecting each occurrence of the first high-level application event; and
monitoring the count to determine if the performance target is being met.

10. The method as recited in claim 8, further comprising extracting the performance target from a service level agreement.

11. The method as recited in claim 8, wherein the first high-level application event is a transaction that includes a series of steps in an execution path of the software application with a common starting point that repeats during execution of the software application.

12. The method as recited in claim 8, further comprising:
generating a second performance metric based on the performance target;
analyzing the software application to detect a second high-level application event which corresponds to the second performance metric;
inserting one or more instructions into the software application to track the second high-level application event; and
monitoring the first high-level application event and the second high-level application event to determine if the performance target is being met.

13. The method as recited in claim 8, further comprising reducing a power state of the one or more processors responsive to determining the performance target is being met.

14. The method as recited in claim 8, further comprising increasing a power state of the one or more processors responsive to determining the performance target is not being met.

15. A non-transitory computer readable storage medium storing program instructions, wherein the program instructions are executable by a processor to:
receive a performance target;
generate a first performance metric based on the performance target;
analyze a software application to detect a first high-level application event which corresponds to the first performance metric;
insert one or more instructions into the software application to track the first high-level application event; and
monitor the first high-level application event to determine if the performance target is being met.

16. The non-transitory computer readable storage medium as recited in claim 15, wherein the program instructions are further executable by a processor to:
insert one or more instructions into the software application to increment a count responsive to detecting each occurrence of the first high-level application event; and
monitor the count to determine if the performance target is being met.

17. The non-transitory computer readable storage medium as recited in claim 15, wherein the program instructions are further executable by a processor to extract the performance target from a service level agreement.

18. The non-transitory computer readable storage medium as recited in claim 15, wherein the first high-level application event is a transaction that includes is a series of steps in an execution path of the software application with a common starting point that repeats during execution of the software application.

19. The non-transitory computer readable storage medium as recited in claim 15, wherein the program instructions are further executable by a processor to:
generate a second performance metric based on the performance target;
analyze the software application to detect a second high-level application event which corresponds to the second performance metric;
insert one or more instructions into the software application to track the second high-level application event; and
monitor the first high-level application event and the second high-level application event to determine if the performance target is being met.

20. The non-transitory computer readable storage medium as recited in claim 15, wherein the program instructions are further executable by a processor to reduce a power state of the one or more processors responsive to determining the performance target is being met.
